(19) United States
(12) Patent Application Publication
(10) Pub. No.: US 2012/0127847 A1
(43) Pub. Date: May 24, 2012

(54) Motor and recording disk drive including the same

(75) Inventor: Chang Jo Yu, Suwon (KR)

(73) Assignee: SAMSUNG ELECTRO-MECHANICS CO., LTD., Suwon (KR)

(21) Appl. No.: 12/929,594

(22) Filed: Feb. 2, 2011

(30) Foreign Application Priority Data
Nov. 22, 2010 (KR) 10-2010-0116430

(51) Int. Cl. G11B 23/00; G11B 21/02

(52) U.S. Cl. 369/215.1; 369/266; G9B/21.003; G9B/23

(57) ABSTRACT

There is provided a motor including a rotating member coupled with a shaft and rotating in connection with the shaft, and a fixing member having the shaft inserted thereinto to support the shaft and including a round part whose outer surface corresponding to the rotating member is formed to be rounded to thereby allow oil to be sealed between the round part and the rotating member.

### CROSS-REFERENCE TO RELATED APPLICATIONS

This application claims the priority of Korean Patent Application No. 10-2010-0116430 filed on Nov. 22, 2010, in the Korean Intellectual Property Office, the disclosure of which is incorporated herein by reference.

### BACKGROUND OF THE INVENTION

1. Field of the Invention

The present invention relates to a motor and a recording disk drive including the same, and more particularly, to a motor including a fluid dynamic pressure bearing assembly and a recording disk drive including the same.

2. Description of the Related Art

One of various types of information storage devices, a hard disk drive (HDD) is a device that uses a read/write head to reproduce data stored on a disk or to record data thereon.

The hard disk drive requires a disk drive capable of driving a disk. A small spindle motor is used for the disk driving device.

The small spindle motor uses a fluid dynamic pressure bearing assembly. In the fluid dynamic pressure bearing assembly, oil is filled between a rotating member, i.e., a shaft, and a fixing member, i.e., a sleeve. The shaft is supported by fluid pressure generated by the oil.

In addition, the oil filled between the rotating member and the fixing member of the spindle motor is sealed by using a capillary phenomenon and the surface tension of oil. The amount of oil, the interfacial position of oil, and the like, are important factors influencing the characteristics of the motor.

That is, when the amount of oil is reduced at a level lower than a normal level of oil due to various factors, such as the evaporation and leakage of oil, or the like, bubbles may be introduced from the outside and friction between the rotating member and the fixing member increased, such that securing a levitation force for rotation is difficult, thereby causing the rotation characteristics of the rotating member to be deteriorated.

Further, the oil may escape from a normal oil interface by an external impact, an excessive injection of oil, a reduction in filling volume, and oil expansion according to the increase in temperature due to the rotation of the rotating member, which may pollute a disk storing data to thereby cause the characteristics of a spindle motor to be deteriorated.

Therefore, in order to improve the performance of a hard disk drive (HDD) adopting the spindle motor and maximize the lifespan thereof, research into an oil sealing structure is required.

### SUMMARY OF THE INVENTION

An aspect of the present invention provides a motor capable of securing a wide oil sealing section to prevent a deterioration in the performance of a motor due to the leakage of oil and maximizing the rigidity of a hub to prevent the deformation of the hub caused by a clamp for fixing a disk, and a recording disk drive including the same.

According to an aspect of the present invention, there is provided a motor, including: a rotating member coupled with a shaft and rotating in connection with the shaft; and a fixing member having the shaft inserted thereinto to support the shaft and including a round part whose outer surface, corresponding to the rotating member, is formed to be rounded to thereby allow oil to be sealed between the round part and the rotating member.

The round part may be formed on a top surface of the fixing member.

The round part may be formed in a radial outside direction from one end of the inner peripheral surface of the fixing member.

One surface of the rotating member corresponding to the round part may be formed to be rounded.

The round part and the rotating member corresponding to the round part may have the same curvature radius.

The round part may be configured to include a first round section formed to be rounded downwardly in an axial direction and a second round section formed to be rounded downwardly in the axial direction from a top portion of one end of the first round section.

The fixing member may include a circulation hole formed to communicate the top and bottom portions thereof and the round part is formed outwardly of the circulation hole.

The round part may be formed on a top outer peripheral surface of the fixing member, and has a diameter reduced downwardly in an axial direction.

At least one of the round part and one surface of the rotating member corresponding to the round part may be provided with a pumping groove to introduce the oil between the shaft and the fixing member.

The pumping groove may be formed to have at least one of a spiral shape, a herringbone shape, and a helix shape.

According to another aspect of the present invention, there is provided a motor, including: a hub coupled with a shaft and rotating in connection with the shaft; a sleeve having the shaft inserted thereinto and supporting the shaft; main wall part formed to be protruded from one surface of the hub, wherein oil is filled between the sleeve and the main wall part; and a round part forming an outer surface of the sleeve corresponding to the main wall part to be rounded, wherein oil is filled between the main wall parts and the round part.

The round part may be formed on a top surface of the sleeve.

The round part may be formed in a radial outside direction from one end of the inner peripheral surface of the sleeve.

One surface of the main wall part corresponding to the round part may be formed to be rounded.

The round part and the one surface of the one surface of the main wall part corresponding to the round part have the same curvature radius.

The round part may be configured to include a first round section formed to be rounded downwardly in an axial direction and a second round section formed to be rounded downwardly in the axial direction from a top portion of one end of the first round section.

The sleeve may include a circulation hole formed to communicate the top and bottom portions thereof and the round part is formed outwardly of the circulation hole.

In the main wall part, a diameter of an inner peripheral surface thereof is reduced downwardly in an axial direction in order to correspond to the round part.

The diameter of the inner peripheral surface of the main wall part may be reduced downwardly in an axial direction.

At least one of the round part and one surface of the main wall part corresponding to the round part maybe provided with a pumping groove to introduce the oil between the shaft and the sleeve.

The pumping groove may be formed to have at least one of a spiral shape, a herringbone shape, and a helix shape.

According to another aspect of the present invention, there is provided a recording disk drive, including: a motor of any one of claims 1 to 21 rotating a recording disk; a head transfer part transferring a head detecting information on the recording disk mounted on the motor to the recording disk; and a housing receiving the motor and the head transfer part.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a motor according to a first exemplary embodiment of the present invention;

FIG. 2A is a cut-away perspective view schematically showing a hub provided in the motor according to the first exemplary embodiment of the present invention, and FIG. 2B is a perspective view schematically showing a sleeve provided in the motor according to the first exemplary embodiment of the present invention;

FIG. 3 is a cross-sectional view schematically showing a motor according to a second exemplary embodiment of the present invention;

FIG. 4 is a cut-away perspective view schematically showing a sleeve provided in the motor according to the second exemplary embodiment of the present invention;

FIG. 5 is a cross-sectional view schematically showing a motor according to a third exemplary embodiment of the present invention;

FIG. 6 is a cut-away perspective view schematically showing a sleeve provided in the motor according to the third exemplary embodiment of the present invention;

FIG. 7 is a cross-sectional view schematically showing a motor according to a fourth exemplary embodiment of the present invention;

FIG. 8 is a cut-away perspective view schematically showing a sleeve provided in the motor according to the fourth exemplary embodiment of the present invention;

FIG. 9 is a cross-sectional view schematically showing a motor according to a fifth exemplary embodiment of the present invention;

FIG. 10A is a cut-away perspective view schematically showing a hub provided in the motor according to the fifth exemplary embodiment of the present invention; and FIG. 10B is a perspective view schematically showing a sleeve provided in the motor according to the fifth exemplary embodiment of the present invention; and

FIG. 11 is a cross-sectional view schematically showing a recording disk drive including the motor according to the embodiments of the present invention.

### DETAILED DESCRIPTION OF THE PREFERRED EMBODIMENT

Hereinafter, various exemplary embodiments of the present invention will be described with reference to the accompanying drawings. However, the exemplary embodiments of the present invention may be modified in many different forms and the scope of the invention should not be limited to the embodiments set forth herein.

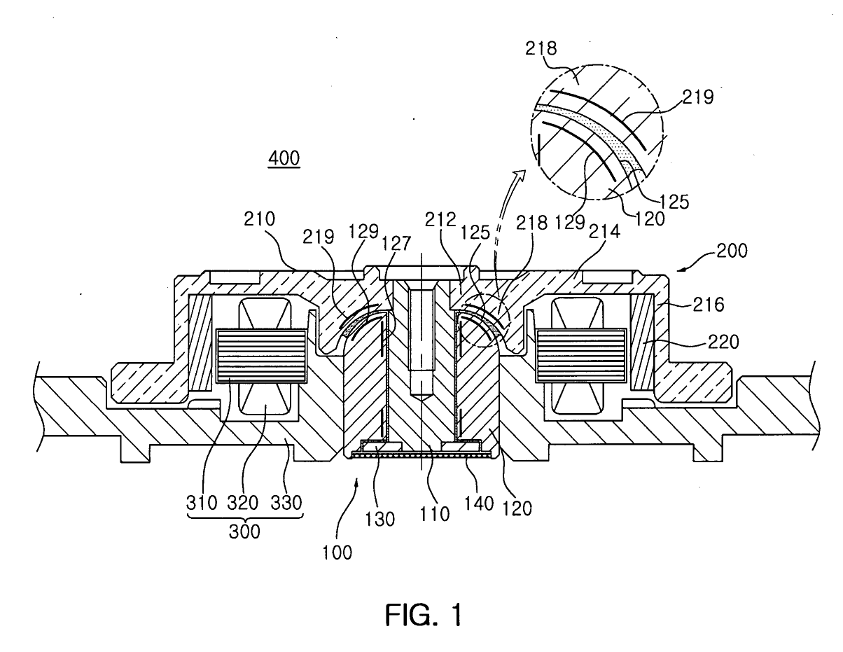

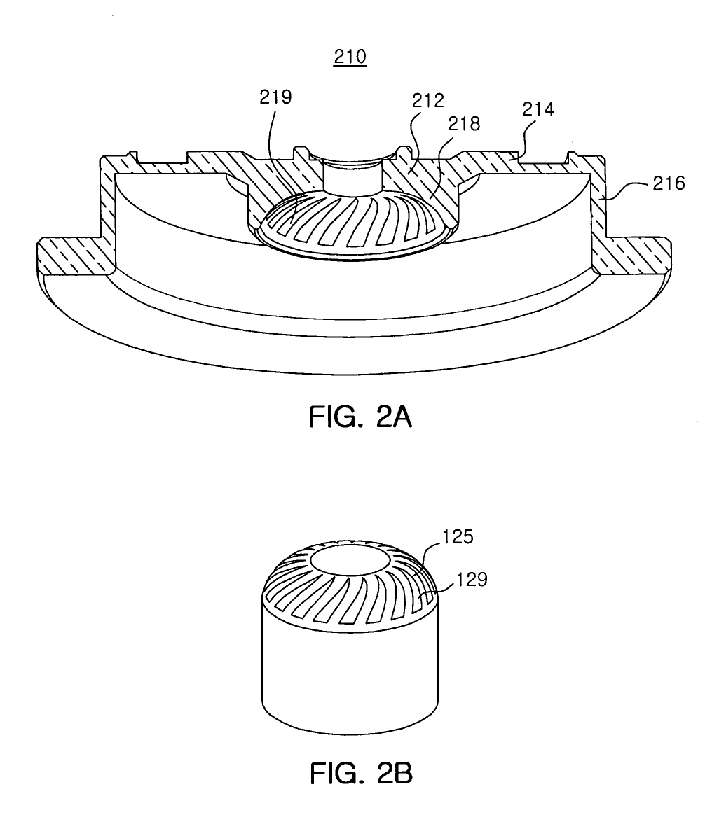

Like reference numerals in the drawings denote like elements, and thus their description will be omitted. FIG. 1 is a cross-sectional view schematically showing a motor according to a first exemplary embodiment of the present invention. FIG. 2A is a cut-away perspective view schematically showing a hub provided in the motor according to the first exemplary embodiment of the present invention, and FIG. 2B is a perspective view schematically showing a sleeve provided in the motor according to the first exemplary embodiment of the present invention.

Referring to FIGS. 1 and 2, a motor 400 according to a first exemplary embodiment of the present invention may be configured to include a fluid dynamic pressure bearing assembly 100 including a shaft 110 and a sleeve 120, a rotor 200 rotating in connection with the shaft 110, and a stator 300 including a core 310 around which a coil 320 is wound.

First, terms for directions are defined. When viewed in FIGS. 1, 3, 5, 7, and 9, an axial direction refers to a vertical direction based on a shaft 110. A radial outside direction refers to an outer end direction of the hub 210, based on the shaft 110 while a radial inside direction refers to a central direction of the shaft 110, based on the outer end of the hub 210.

The sleeve 120 may refer to a fixing member coupled with a base member 330, into which the core 310 to be described below is inserted and fixed, and supporting the rotating member including the shaft 110.

The sleeve 120 may support the shaft 110 such that the upper end of the shaft 110 is upwardly protruded in the shaft direction and may be formed by forging Cu or Al or sintering Cu—Fe-based alloy powder or SUS-based powder.

In this configuration, the shaft 110 is inserted in such a manner as to have a small clearance with a shaft hole of the sleeve 120. The small clearance is filled with oil, so that the rotation of a rotor 200 may be smoothly supported by a radial dynamic pressure groove 127 formed in at least one of the outer diameter of the shaft 110 and the inner diameter of the sleeve 120.

The radial dynamic pressure groove 127 is formed inside the sleeve 120 which is the inside of the shaft hole of the sleeve 120 and forms a pressure so as to be biased to one side when the shaft 110 is rotated.

However, the formation of the radial dynamic pressure groove 127 is not limited to the case where it is provided in the inner side of the sleeve 120 as described above. The radial dynamic pressure groove 127 may also be provided at the outer diameter portion of the shaft 110 and may not be limited to the number thereof. The radial dynamic pressure groove 127 may be any one of a herringbone shape, a spiral shape, and a helix shape. However, the radial dynamic pressure groove 127 is not limited to the shape thereof, as long as it generates a radial dynamic pressure.

Further, the outer surface of the sleeve 120 may be provided with a round part 125 allowing oil to be sealed between main wall parts 218 of the rotor 200 that is a rotating member to be described below.

The round part 125 shows that a portion of the top outer surface of the sleeve 120 is formed to be rounded and may correspond to the top surface of the sleeve 120.

In other words, the round part 125 may be formed to be rounded in the radial outside direction from one end of the inner peripheral surface of the sleeve 120. The outer diameter of the top side of the sleeve 120 on which the round part 125 is formed may be gradually increased downwardly in the axial direction.

In other words, the outer diameter of the top side of the sleeve 120 may be non-linearly increased downwardly in the axial direction.

In this case, the round part 125 may have a spherical or oval shape and may have the same curvature radius as that of one surface of the main wall part 218 to be described below corresponding to the round part 125.

In addition, when the round part 125 may be provided with a pumping groove 129 to introduce the oil in the oil interfacial direction when the oil escapes from the normal oil interface due to the external impact or the oil expansion according to the increase in temperature. The pumping groove 129 may be also formed on one surface of the main wall part 218 corresponding to the round part 125.

In this configuration, the pumping groove 129 may be a spiral shape that is an anti-herringbone shape; however, which is not limited thereto. The pumping groove 129 is not limited to a shape thereof, as long as it may introduce the oil escaped from the normal oil interface into a normal oil interfacial direction. That is, the pumping groove 129 may have a herringbone shape or a helix shape.

Therefore, the pumping groove 129 performs an important function in the motor 400 according to an exemplary embodiment of the present invention, in which the amount of oil and the oil interfacial position are important. In other words, the pumping groove 129 may allowing for minimizing noise, vibrations, and non-repeatable runout caused by the leakage of oil due to the external impact or the temperature rising, such that the lifespan of the motor 400 according to an exemplary embodiment of the present invention may be maximized.

In addition, the bottom part of the sleeve 120 may be provided with a thrust plate 130 and the center of the thrust plate 130 is provided with a hole corresponding to a cross section of the shaft 110. Theshaft 110 may be inserted into the hole. In this case, the thrust plate 130 may be separately manufactured and coupled with the shaft 110. However, the thrust plate 130 may be integrally formed with the shaft 110 from the beginning of manufacturing and may be rotated along the shaft 110 at the time of the rotary motion of the shaft 110.

The top surface and the bottom surface of the thrust plate 130 may be provided with the thrust dynamic pressure groove providing the thrust dynamic pressure to the shaft 110. The top surface of the thrust plate 130 may have the spiral shape and the bottom surface thereof may have a herringbone shape.

However, as described above, the thrust dynamic pressure groove formed on the top surface and the bottom surface of the thrust plate 130 may have the spiral shape and the herringbone shape; however, it is not necessarily limited thereto. The thrust dynamic groove is not limited to a shape thereof, as long as it may provide the thrust dynamic pressure.

In addition, a cover plate 140 may be coupled with the sleeve 120 downwardly in the shaft direction of the sleeve 120, while having a clearance maintained therebetween, which receives oil. The cover plate 140 receives oil in the clearance between the cover plate 140 and the sleeve 120 to thereby being capable of serving as a bearing supporting the bottom surface of the shaft 110.

The rotor 200 is a rotation structure rotatably provided with respect to the stator 300 to be described below and may be provided with the hub 210 having an annular ring magnet 220 provided at the inner peripheral surface thereof, which corresponds to the core 310 to be described later at a predetermined distance.

In other words, the hub 210 may be a rotating member that is coupled with the top side of the shaft 110 to be rotated in connection with the shaft 110.

The magnet 220 may be a permanent magnet generating a predetermined strength of magnetic force by alternately magnetizing an N pole and an S pole in a circumferential direction thereof.

Further, the hub 210 may include a first cylindrical wall part 212 fixed to the top end of the shaft 110, a disk part 214 formed to be extended to the radial outside from the end of the first cylindrical wall part 212, and a second cylindrical wall part 216 protruded downwardly from the radial outside end of the disk plate 214. The inner peripheral surface of the second cylindrical wall part 216 may be combined with the magnet 220.

Further, the hub 210 may allow for sealing oil between the top outsides of the sleeve 120, that is, between the above-mentioned round parts 125 and may include a main wall part 218 formed to be extended downwardly in the axial direction in order to allowing for the sealing of oil.

In this configuration, the main wall part 218 may be rounded to correspond to the round part 125 and the entire surface thereof corresponding to the sleeve 120 may be formed to be rounded other than a portion of the main wall part 218 inserted into and coupled with the shaft 110.

Therefore, the diameter of inner peripheral surface of the main wall part 218 may be increased downwardly in the axial direction.

Further, the main wall part 218 may have a spherical or oval shape, similar to the round part 125 and may have the same curvature radius as that of the round part 125.

By the above-mentioned structure, the thickness of the main wall part 218 is increased and the rigidity of the hub 210 including the main wall part 218 is correspondingly increased.

The increased rigidity of the hub 210 can prevent the deformation of the hub 210 due to the clamp (not shown) necessary to fix the disk storing data to the hub 210, thereby making it possible to prevent errors caused when reproducing data stored on the disk or recording data on the disk.

Further, when machining the hub 210, the thickness of the main wall part 218 is thick, such that the outside of the main wall part 218 may be fixed by a strong chucking pressure, thereby making it possible to improve the machining precision of the hub 210. As a result, the precision to fix the disk to the hub 210 is improved, thereby making it possible to prevent errors when recording data on the disk or reproducing data recorded on the disk.

In this case, one surface of the main wall part 218 corresponding to the round part 125 may be provided with the pumping groove 29 introducing the oil filled between the round part 125 and the main wall part 218 in the oil interfacial direction. The structure and effects of the pumping groove 219 are the same as the pumping groove 129 formed in the round part 125. However, the pumping grooves 129 and 219 may be formed in both the round part 125 and the main wall part 218, but may be formed in any one of the round part 125 and the main wall part 218.

The stator 300 is a fixing member in which an insertion hole is formed and may refer to all the fixed components other than rotating components, but is considered to include the core 310, the coil 320, and the base member 330 for convenience of explanation.

The stator 300 may be a fixing structure that includes the coil 320 generating a predetermined strength of electromagnetic force when power is applied thereto and a plurality of cores 310 around which the coil 320 is wound.

The core 310 is fixedly disposed on the top portion of the base member 330 on which a printed circuit board (not shown) printed with pattern circuits is provided and a plurality of coil holes having a predetermined size may be formed, penetrating through the top surface of the base member 330 corresponding to the winding coil 320, in order to expose the winding coil 320 downwardly. The winding coil 320 is electrically connected to the printed circuit board (not shown) in order to supply external power thereto.

The base member 330 may be inserted with the core 310 to which the outer peripheral surface of the sleeve 120 is fixed and the coil 320 is wound. Meanwhile, the base member 330 and the sleeve 120 may be assembled by applying an adhesive to the inner surface of the base member 230 or the outer surface of the sleeve 120.

Considering the oil filled between the round part 125 formed in the sleeve 120 and the main wall part 218 corresponding to the round part 125 and the oil interface, the motor 400 according to the first exemplary embodiment of the present invention may form the rounded oil sealing path.

Therefore, the oil amount may be maximally stored due to the increased oil sealing path and the leakage of oil may be prevented due to the a rise in temperature, an external impact, or the like.

In addition, the interval between the round part 125 and the main wall part 218 may be gradually increased in the radial outside direction and the oil sealing path is opened downwardly in the axial direction, thereby making it possible to measure the injection amount of oil.

In addition, the leakage of oil can be previously prevented by the pumping grooves 129 and 219 formed on least one of the round part 125 and the main wall part 218, such that the normal oil interface can be maintained, thereby making it possible to maximize the performance of the motor 400 according to the present invention.

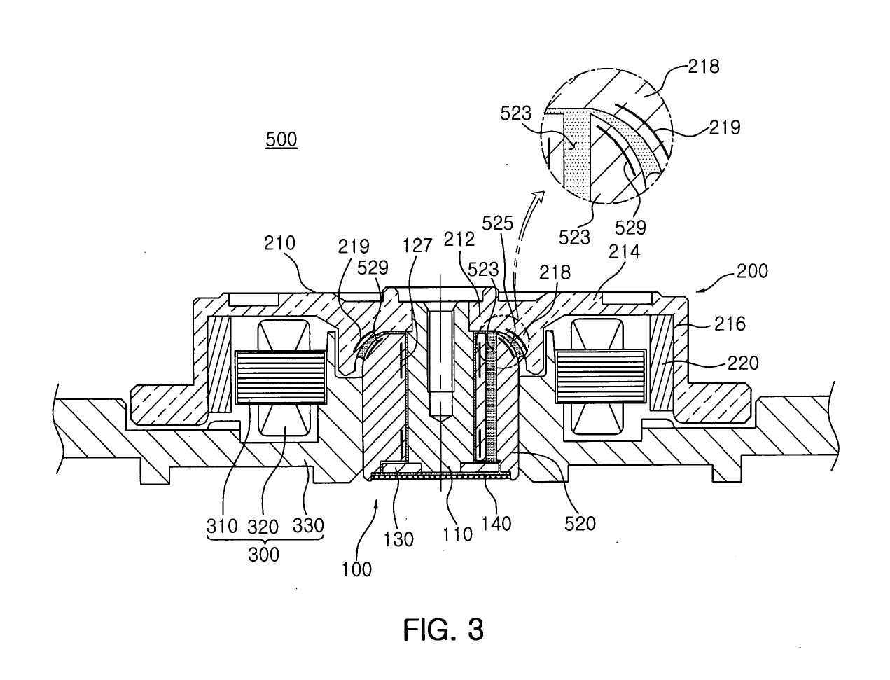

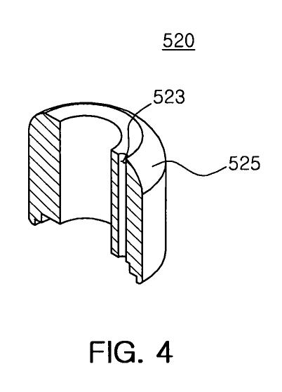

FIG. 3 is a cross-sectional view schematically showing a motor according to a second exemplary embodiment of the present invention and FIG. 4 is a cut-away perspective view schematically showing a sleeve provided in the motor according to the second exemplary embodiment of the present invention.

Referring to FIGS. 3 and 4, a motor 500 according to a second exemplary embodiment of the present invention has the same components and effects as those of the motor 400 according to the first exemplary embodiment of the present invention other than a sleeve 520 and therefore, the description of the components other than the sleeve 520 will be omitted.

The sleeve 520 may be provided with a circulation hole 523 formed to communicate the top and bottom portions thereof. The circulation hole 523 may disperse the pressure of oil inside the fluid dynamic pressure bearing assembly 100 to maintain a balance thereof and may discharge bubbles, or the like, existing in the fluid dynamic pressure bearing assembly 100 by circulation.

In this case, a round part 525 formed in the sleeve 520 may be formed at the outer side of the circulation hole 523 and the main wall part 218 corresponding to the round part 525 may be also formed to be rounded from the outer side of the circulation hole 523 after the area corresponding to the circulation hole 523 maintains a horizontal surface.

In addition, at least one of the round part 525 and the main wall part 218 may be provided with the above-mentioned pumping grooves 219 and 529. In this case, the oil may be introduced into the oil interfacial direction by the pumping grooves 219 and 529, thereby making it possible to prevent the leakage of oil.

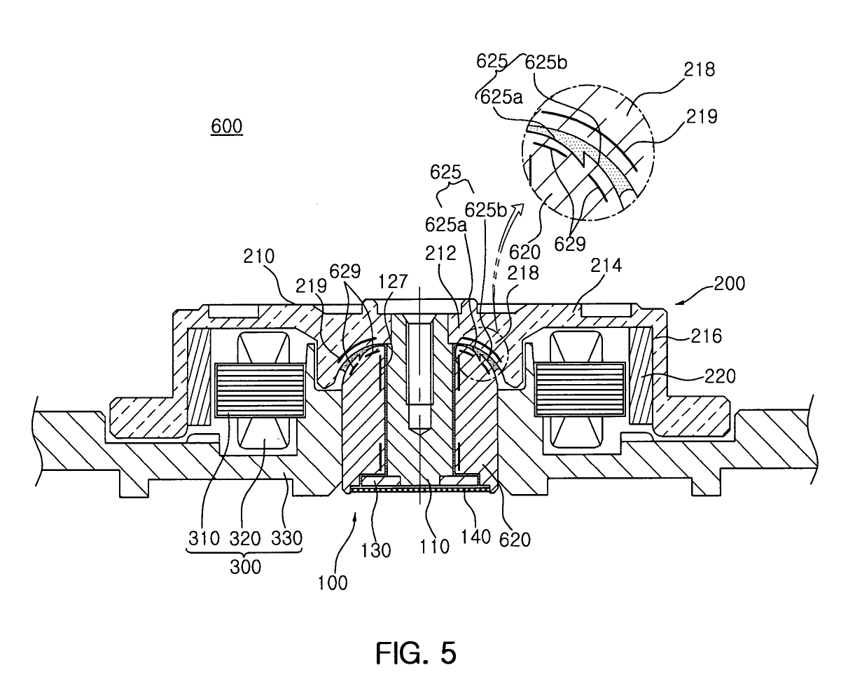

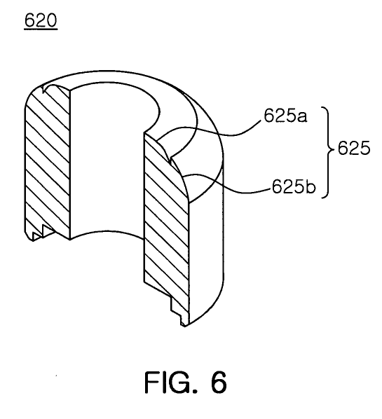

FIG. 5 is a cross-sectional view schematically showing a motor according to a third exemplary embodiment of the present invention and FIG. 6 is a cut-away perspective view schematically showing a sleeve provided in a motor according to the third exemplary embodiment of the present invention.

Referring to FIGS. 5 and 6, a motor 600 according to a third exemplary embodiment of the present invention has the same components and effects as the motor 400 according to the first exemplary embodiment of the present invention other than a sleeve 620 and therefore, the description of the components other than the sleeve 620 will be omitted.

The round part 625 formed in the sleeve 620 may be configured to include a first round section 625a formed to be rounded downwardly in the axial direction from one end of the inner peripheral surface of the round part 625 and a second round section 625b formed to be rounded downwardly in the axial direction from the top portion of one end of the first round section 625a.

However, the round part 625 is not limited as being configured to include two round sections, that is, the first and second round sections 625a and 625b and therefore, it could be modified by a person having ordinary skill in the art without departing from the spirit of the present invention.

In this case, the oil may be stored in a space between the boundary of the first round section 625a and the second round section 625b, and the main wall part 218, and the amount of oil stored in the space may be increased.

Therefore, the degradation in performance of the motor 600 according to the present invention due to the evaporation and leakage of oil can be prevented.

Further, each of the first round section 625a and the second round section 625b may be provided with the pumping groove 629 and the oil may be introduced into the fluid dynamic pressure bearing assembly by the pumping groove 629.

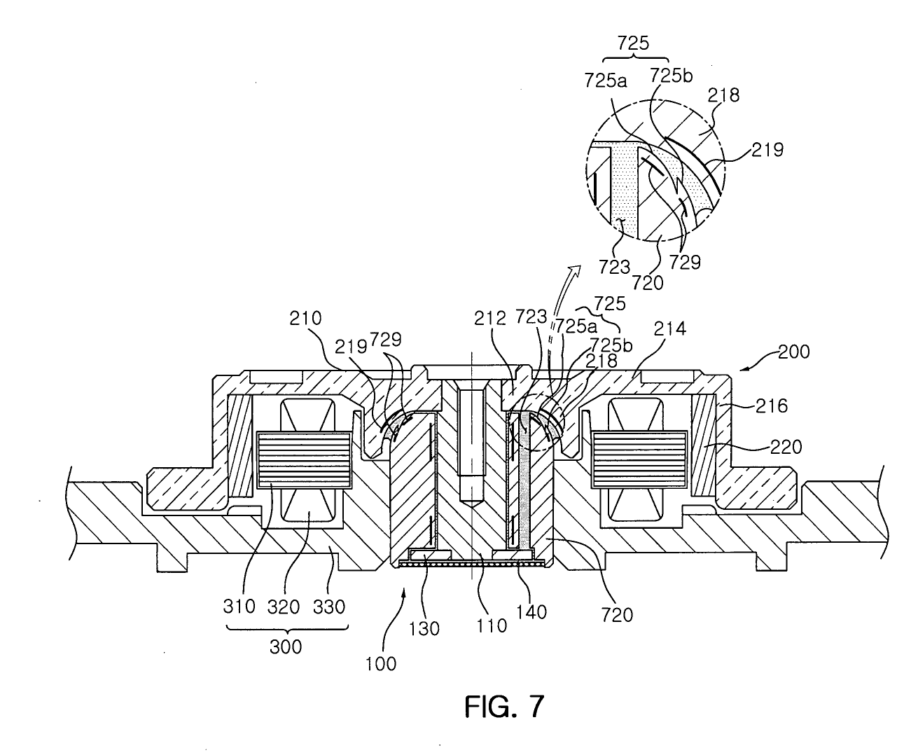

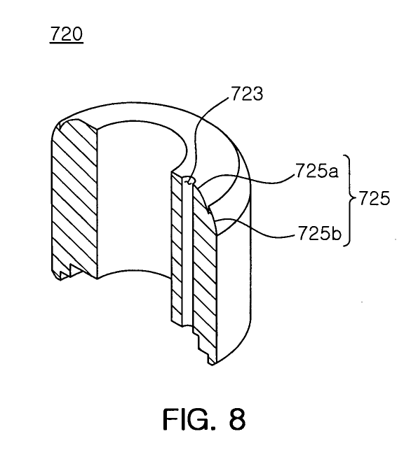

FIG. 7 is a cross-sectional view schematically showing a motor according to a fourth exemplary embodiment of the present invention and FIG. 8 is a cut-away perspective view schematically showing a sleeve provided in the motor according to the fourth exemplary embodiment of the present invention.

Referring to FIGS. 7 and 8, a motor 700 according to a fourth exemplary embodiment of the present invention has the same components and effects as those of the motor 600 according to the third exemplary embodiment of the present invention other than a circulation hole 723 and therefore, the description of the components other than the circulation hole 723 will be omitted.

The round part 725 formed in the sleeve 720 may be formed outwardly of the circulation hole 723 and the first round section 725a and the second round section 725b may be formed outwardly of the circulation hole 723.

The main wall part 218 corresponding to the round part 725 may be formed to be rounded from the outer side of the circulation hole 723, while an area thereof corresponding to the circulation hole 723 maintains the horizontal surface.

In addition, at least one of the round part 725 and the main wall part 218 may be provided with the above-mentioned pumping grooves 219 and 729. In this case, the oil may be introduced into the fluid dynamic pressure bearing assembly 100 by the pumping grooves 219 and 729, thereby making it possible to prevent the leakage of oil.

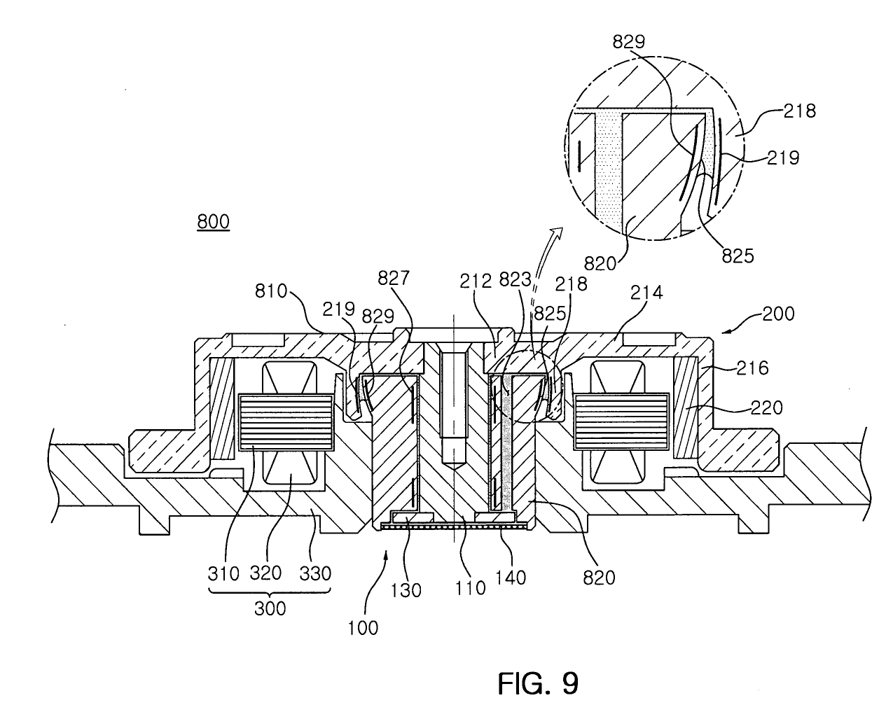

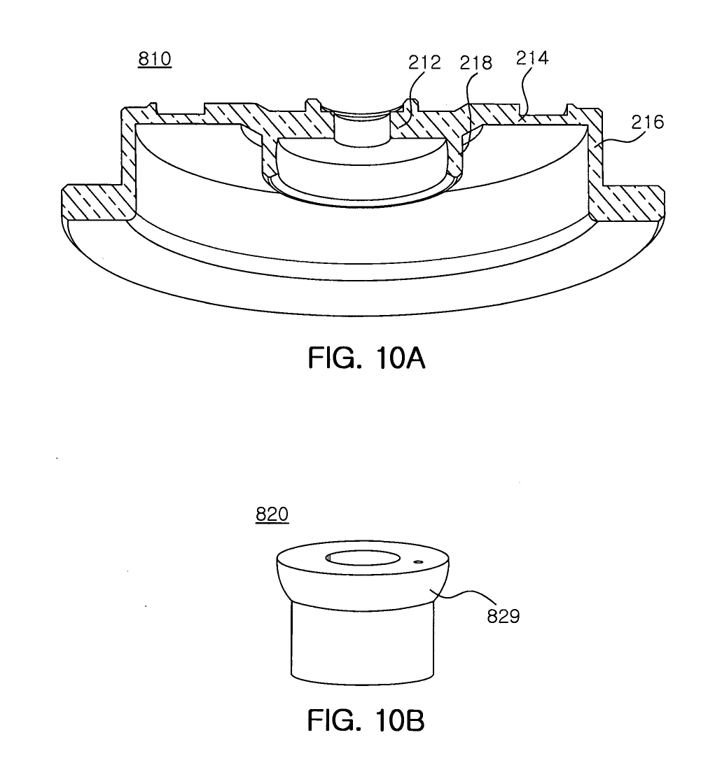

FIG. 9 is a cross-sectional view schematically showing a motor according to a fifth exemplary embodiment of the present invention. FIG. 10A is a cut-away perspective view schematically showing a hub provided in the motor according to the fifth exemplary embodiment of the present invention; and FIG. 10B is a perspective view schematically showing a sleeve provided in the motor according to the fifth exemplary embodiment of the present invention.

Referring to FIGS. 9 and 10, a top outer peripheral surface of a sleeve 820 provided in a motor 800 according to a fifth exemplary embodiment of the present invention is formed to be rounded, such that the sleeve 820 may include the round part 825.

The round part 825 may be formed at the top outer peripheral surface of the sleeve 820 and the diameter of the sleeve 820 may be reduced downwardly in the axial direction.

In other words, the diameter of the sleeve 820 may be non-linearly reduced downwardly in the axial direction by the round part 825.

The top surface of the sleeve 820 may be disposed at a clearance from the bottom surface of the first cylindrical wall part 212 of the hub 810 and the main wall part 218 may be formed to be protruded downwardly in the axial direction from the outer side of the top surface of the sleeve 820.

The main wall part 218 may be formed to be rounded to correspond to the round part 825 and the diameter of the inner peripheral surface thereof may be non-linearly reduced downwardly in the axial direction.

However, the clearance between the round part 825 and the main wall part 218 may be increased downwardly in the axial direction.

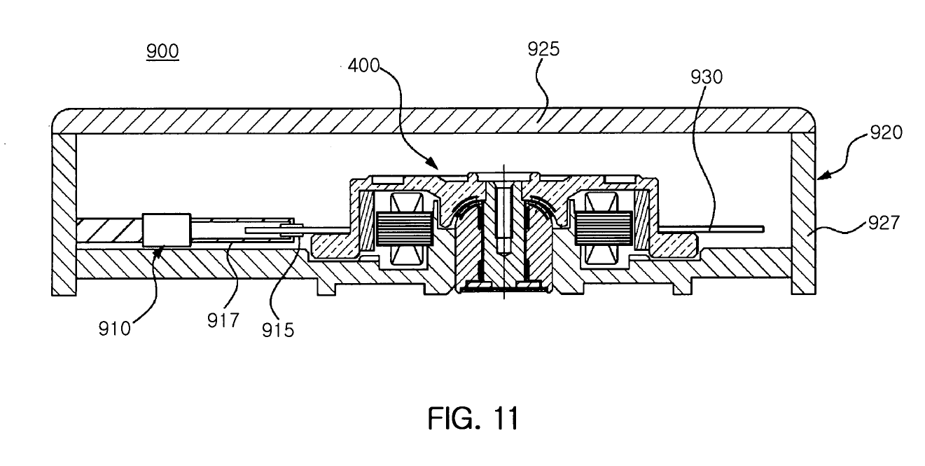

FIG. 11 is a cross-sectional view schematically showing a recording disk drive including a motor according to an embodiment of the present invention.

Referring to FIG. 11, a device 900 for driving a recording disk including the motor 400 according to an embodiment of the present invention is a hard disk drive and may be configured to include a motor 400, a head transfer part 910, and a housing 920.

The motor 400 has all the above-mentioned features of the motor according to the embodiments of the present invention and may mount a recording disk 930 thereon.

FIG. 11 shows the motor 400 according to an exemplary embodiment of the present invention; however, the present invention is not limited thereto, and all above-mentioned motors 500, 600, 700, and 800 may be applied thereto.

The head transfer part 910 may transfer a head 915 detecting information on the recording disk 930 mounted on the motor 400 to the surface of the recording disk to be detected.

In this case, the head 915 may be disposed on a supporting part 917 of the head transfer part 910.

The housing 920 may be configured to include a motor mounting plate 927 and a top cover 925 shielding the top portion of the motor mounting plate 927 in order to form the inner space receiving the motor 400 and the head transfer part 910.

According to the above-mentioned exemplary embodiments, the motors 400, 500, 600, 700, and 800 according to the present invention and the recording disk drive 900 secures the wide oil sealing section between the round parts 125, 525, 625, 725, and 825 formed in the sleeves 120, 520, 620, 720, and 820 and the main wall part 218 corresponding to the round parts 125, 525, 625, 725, and 825, thereby making it possible to prevent the deterioration in performance of the motors 400, 500, 600, 700, and 800 due to the leakage of oil.

Further, the present invention can secure the rigidity of the hubs 210 and 810, rotating members, thereby making it possible to prevent the deformation of the hubs 210 and 810 due to the clamp (not shown) for fixing the disk.

Further, the present invention can previously prevent the leakage of oil due to the pumping grooves 129, 219, 529, 629, 729, and 829 formed in at least one of the round parts 125, 525, 625, 725, and 825 and the main wall part 218 to maintain the oil interface at a normal level, thereby making it possible to maximize the performance of the motor 400, 500, 600, 700, and 800 and the recording disk drive according to the present invention.

As set forth above, according to embodiments of the present invention, the motor and the recording disk drive including the same can prevent the leakage of oil due to the increase in temperature, the external impact, or the like, thereby making it possible to improve the performance of the motor. Further, the motor and the recording disk drive including the same according to the embodiments of the present invention can maximize the rigidity of the hub to prevent the deformation of the hub due to the clamp and maximize the storable amount of oil to maximize the lifespan of the motor.

While the present invention has been shown and described in connection with the exemplary embodiments, it will be apparent to those skilled in the art that modifications and variations can be made without departing from the spirit and scope of the invention as defined by the appended claims.

What is claimed is:

1. A motor comprising:
a rotating member coupled with a shaft and rotating in connection with the shaft; and
a fixing member having the shaft inserted thereinto to support the shaft and including a round part whose outer surface, corresponding to the rotating member, is formed to be rounded to thereby allow oil to be sealed between the round part and the rotating member.

2. The motor of claim 1, wherein the round part is formed on a top surface of the fixing member.

3. The motor of claim 1, wherein the round part is formed in a radial outside direction from one end of the inner peripheral surface of the fixing member.

4. The motor of claim 1, wherein one surface of the rotating member corresponding to the round part is formed to be rounded.

5. The motor of claim 4, wherein the round part and the rotating member corresponding to the round part have the same curvature radius.

6. The motor of claim 1, wherein the round part is configured to include a first round section formed to be rounded downwardly in an axial direction and a second round section formed to be rounded downwardly in the axial direction from a top portion of one end of the first round section.

7. The motor of claim 1, wherein the fixing member includes a circulation hole formed to communicate the top and bottom portions thereof and the round part is formed outwardly of the circulation hole.

8. The motor of claim 1, wherein the round part is formed on a top outer peripheral surface of the fixing member, and has a diameter reduced downwardly in an axial direction.

9. The motor of claim 1, wherein at least one of the round part and one surface of the rotating member corresponding to the round part is provided with a pumping groove to introduce the oil between the shaft and the fixing member.

10. The motor of claim 9, wherein the pumping groove is formed to have at least one of a spiral shape, a herringbone shape, and a helix shape.

11. A motor comprising:
a hub coupled with a shaft and rotating in connection with the shaft;
a sleeve having the shaft inserted thereinto and supporting the shaft;
a main wall part formed to be protruded from one surface of the hub, wherein oil is filled between the sleeve and the main wall part; and
a round part forming an outer surface of the sleeve corresponding to the main wall part to be rounded, wherein oil is filled between the main wall parts and the round part.

12. The motor of claim 11, wherein the round part is formed on a top surface of the sleeve.

13. The motor of claim 11, wherein the round part is formed in a radial outside direction from one end of an inner peripheral surface of the sleeve.

14. The motor of claim 11, wherein one surface of the main wall part corresponding to the round part is formed to be rounded.

15. The motor of claim 14, wherein the round part and the one surface of the main wall part corresponding to the round part have the same curvature radius.

16. The motor of claim 11, wherein the round part is configured to include a first round section formed to be rounded downwardly in an axial direction and a second round section formed to be rounded downwardly in the axial direction from a top portion of one end of the first round section.

17. The motor of claim 11, wherein the sleeve includes a circulation hole formed to communicate the top and bottom portions thereof and the round part is formed outwardly of the circulation hole.

18. The motor of claim 11, wherein the round part is formed on a top outer peripheral surface of the sleeve and has a diameter reduced downwardly in an axial direction.

19. The motor of claim 18, wherein in the main wall part, a diameter of an inner peripheral surface thereof, is reduced downwardly in an axial direction in order to correspond to the round part.

20. The motor of claim 11, wherein at least one of the round part and one surface of the main wall part corresponding to the round part is provided with a pumping groove to introduce the oil between the shaft and the sleeve.

21. The motor of claim 20, wherein the pumping groove is formed to have at least one of a spiral shape, a herringbone shape, and a helix shape.

22. A recording disk drive comprising:
a motor of claim 1 rotating a recording disk;
a head transfer part transferring a head detecting information on the recording disk mounted on the motor to the recording disk; and
a housing receiving the motor and the head transfer part.

23. A recording disk drive comprising:
a motor of claim 11 rotating a recording disk;
a head transfer part transferring a head detecting information on the recording disk mounted on the motor to the recording disk; and
a housing receiving the motor and the head transfer part.
